(19) United States
(12) Patent Application Publication
(10) Pub. No.: US 2003/0115319 A1
(43) Pub. Date: Jun. 19, 2003

(54) Network paths

(76) Inventors: Jeffrey L. Dawson, Carlisle, MA (US); Irvin C. Schick, Newton, MA (US); Nathaniel Duca, Wenham, MA (US)

Correspondence Address: FISH & RICHARDSON PC, 225 FRANKLIN ST, BOSTON, MA, 02110, US

(21) Appl. No.: 10/024,408

(22) Filed: Dec. 17, 2001

(51) Int. Cl. G06F 15/173; G06F 15/16

(52) U.S. Cl. 709/224; 709/218

(57) ABSTRACT

A method for collecting, processing and displaying data related to network paths is provided. The method includes, in a network, in a network, collecting data about a packet passing from a source system to a destination system, generating a markup language graphical file based on the collected data, and displaying the markup language graphics file.

### TECHNICAL FIELD

This invention relates to network paths.

### BACKGROUND

In a network, packets of data (content) travel from a source network node to a destination network node along a path through one or more intermediate network nodes located in a single network or multiple networks. The path between a source network node and the destination network node, and any intermediate network nodes, is referred to as a route. Knowledge of the source, destination and any intermediate network nodes within the network(s) provides information for efficient flow of content through the network(s).

### SUMMARY

According to one aspect of the invention, a method includes, in a network, collecting data from a source system to destination systems, generating a markup language graphics file for the collected data, and displaying the markup language graphics file.

One or more of the following features may also be included. Collecting may include tracing routes from the source system to the destination systems, and for each of the routes, storing a node identification, a hop time, and a travel time from the source system to an intermediate node. Node identification may include a node name and/or an IP address.

Generating may include determining a number of systems in each of the routes, assigning coordinates to each of the systems in each of the routes, and storing the coordinates and associated node identification, hop time, and travel time from source system to each of the systems in each of the routes in the markup language file.

The markup language may be Hypertext Markup Language (HTML) or Extensible Markup Language (XML).

Each of the systems on each of the routes may be positioned on an imaginary line emanating from a center of a geometric structure. The geometric structure may be a circle or a square.

Displaying may include viewing an image represented by the markup language graphics file on browser software. The image may include geometric shapes representing systems in each route and a color of the geometric shapes may represent a network and/or a potential timing problem.

The method may also include displaying a node identification and route timing data when any of the geometric shapes is highlighted by a cursor on an input/output device and/or a time travel histogram of the highlighted geometric shape.

According to another aspect of the invention, a method includes, in a network, tracing routes from a source system to the destination systems, for each of the routes, storing data representing a node identification, a hop time, and a travel time from the source system to an intermediate node, generating an interactive markup language graphics file for the data, and displaying the interactive markup language graphics file.

One or more of the following features may also be included. Generating may include determining a number of systems in each of the routes, assigning coordinates to each of the systems in each of the routes, and storing the coordinates and associated node identification, hop time, and travel time from source system to each of the systems in each of the routes in the markup language file.

Displaying may include viewing an image represented by the markup language graphics file on browser software. The image may include geometric shapes representing systems in each route, and the geometric shapes may be colored to represent a network and/or a potential timing problem.

Displaying may also include a node identification and route timing data when any of the geometric shapes is highlighted by a cursor on an input/output device. Displaying may also include a time travel histogram of the highlighted geometric shape.

The data may be stored on a remote computer system and the interactive markup language graphics file is displayed on a remote system.

Embodiments of the invention may have one or more of the following advantages.

The method collects, processes and displays data related to network paths. The collected data represents the network paths taken by content served by a network content server and round-trip latency at each hop of each path.

The display is web-based and may provide a color-coded image of the network, highlighting areas with high latency.

The method is in continuous operation, running route tracings to multiple targets at a configurable frequency.

The method displays all the paths simultaneously, offering at a glance a picture of hotspots across the network(s) for easy comparison. It allows a user to view data from a large number of separate sources simultaneously in a highly user-friendly environment.

Common points in routes are identified and coordinates are computed for each of the points that are used to produce a display that is easy to understand and pleasant to the eye of a user.

Collected information is displayed as a graph. The graph is in the form of a tree with the network server at the root of the tree and each of the target clients (e.g., network nodes) at a leaf in the tree. The path from the root to a leaf represents the route discovered by tracing paths. Each of the network nodes in the tree is assigned a color and shape representing the time needed to travel to the underlying point on the route and the network on which the underlying router resides.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a network.

FIG. 2 is a flow diagram.

FIG. 3 is a table.

FIG. 4 is a flow diagram.

FIGS. 5A and 5B are block diagrams.

FIG. 6 is a display diagram.

FIG. 7 is a graph.

FIG. 8 is a histogram.

### DETAILED DESCRIPTION

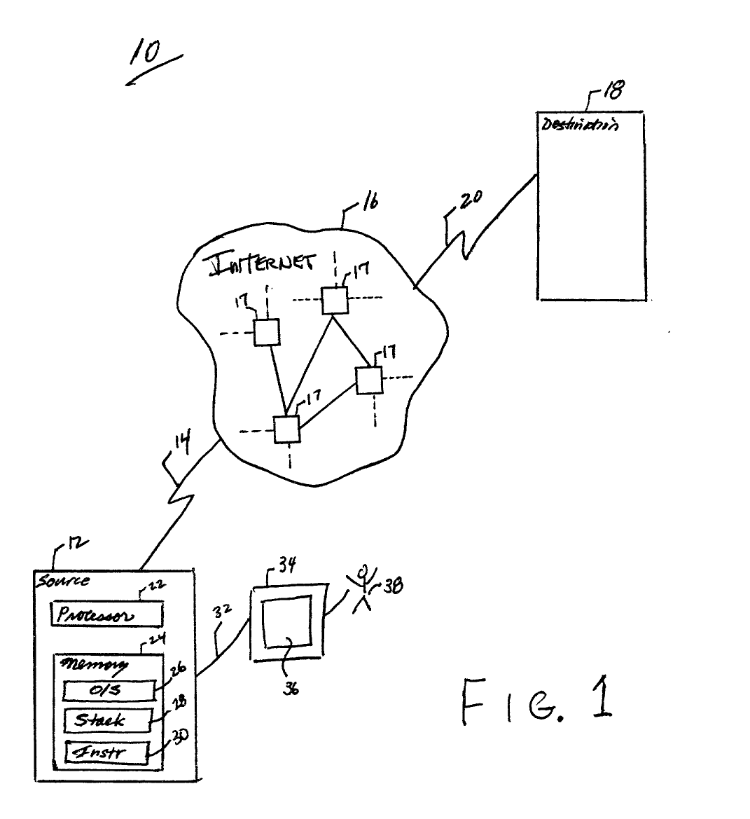

Referring to FIG. 1, a network 10 includes a source network node 12 connected via a link 14 to a global network of interconnected computer systems, e.g., the Internet 16, and destination network node 18 connected to the Internet 16 via a link 20. Because the Internet 16 is a global network of computers each computer, e.g., source network node 12 and destination network node 18, connected to the Internet 16 has a unique address. Internet addresses are in the form nnn.nnn.nnn.nnn, where nnn is a number from 0-255. The addresses comply with an Internet Protocol (IP). For example, source network node 12 may have an IP address 1.2.3.4 and destination network node 18 may have an IP address of 5.6.7.8. Although not shown in FIG. 1, thousands of different source and destination nodes may be connected to the Internet 16.

Each of the network nodes, source network node 12, for example, contains a processor 22 and a memory 24. Memory 24 stores an operating system (“O/S”) 26 and a TCP/IP protocol stack 28 for communicating with the Internet 16. In some cases, the source network node 12 can be called a network server or content server.

The Internet 16 includes many large networks (not shown) that interconnect with each other. The Internet 16 includes one or more network nodes referred to as routers 17. Routers 17 connect one or more networks within the Internet 16 and route packets containing content between networks.

When a packet is sent from the source network node 12 to the Internet 16 the packet arrives at a router 17 residing in the Internet 16, the router 17 examines the IP address of the destination node put there by the IP protocol stack on the source network node. The router 17 checks its routing table (not shown) to find a network containing the IP address. If such a network is found, the packet is sent to that network. Otherwise, the router 17 sends the packet on a default route towards the destination. Eventually, the packet arrives at the destination network node 18.

In a packet-switching network, a hop is the trip a data packet takes from one router or intermediate network node point to another network node point in the network. On the Internet 16 (or other network that uses transmission control protocol/internet protocol (TCP/IP)), the number of hops a packet has taken toward its destination (called the “hop count”) is kept in a header of the packet. A packet with an exceedingly large hop count is discarded because the destination is considered unreachable. The path of packets traveling between the source network node 12 and the destination network node 18, and any intermediate network nodes in the Internet 16, is referred to as a route.

Memory 24 of source network node 12 stores machine-executable instructions 30 executed by processor 22 to perform a route tree process 100, described below. The source network node 12 also includes a link 32 to an input/output device 34 displaying a Graphical User Interface (GUI) 36 to a user 38.

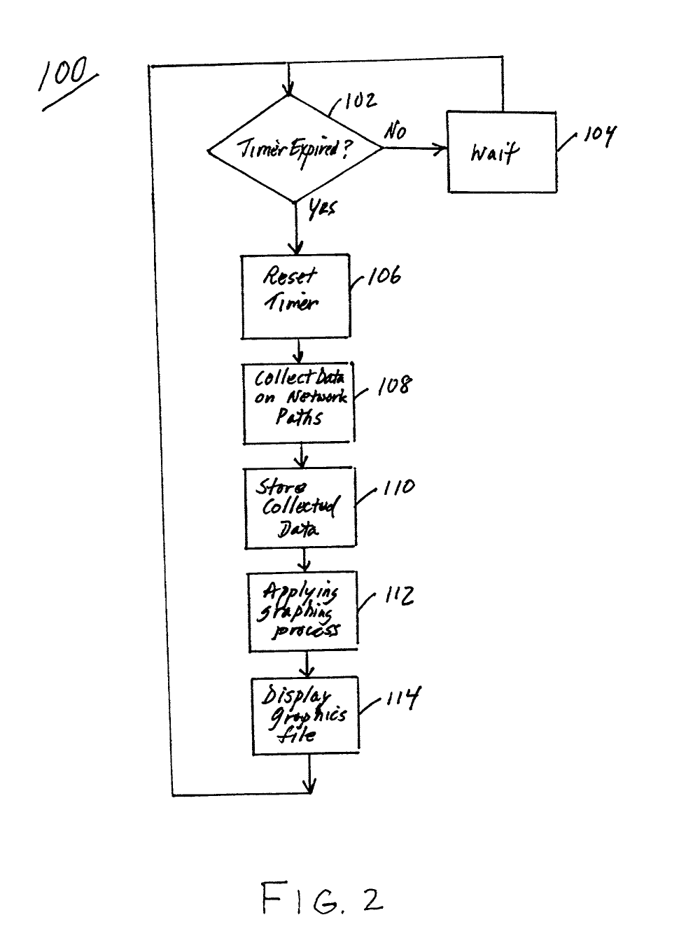

Referring to FIG. 2, the route tree process 100 includes determining (102) whether a timer has expired. The timer is user configurable. If the timer has not expired, the process waits (104) for a predetermined time and then determines (102) whether the timer has expired. If the timer has expired, the process resets (106) the timer and collects (108) data representing network paths taken by content served by the source network node 12 and a round-trip latency experienced at each hop of a group of network paths, where the round-trip latency represents a time from the source to the current node. The source network system 12 maintains a list of clients, i.e., destination network systems. This list is stored in the source network node 12 and is user-configurable. The list represents the IP addresses of the destination network systems.

For each IP address in the list, data collection (108) involves tracing a route taken by content sent from the source network node 12 to, for example, destination network node 18. Tracing can be done using any commercially available tracing program, such as traceroute, for example. Traceroute is a utility that records the route through the Internet 16 between the source network node 12 and a specified destination network node, such as destination network node 18. Traceroute also calculates and records the amount of time each hop took.

The traceroute utility comes included with a number of operating systems, including Windows and UNIX-based operating systems (such as IBM's AIX/6000) or as part of a TCP/IP package. When a traceroute command is entered manually by the user or automatically by a process such as process 100, the traceroute utility sends a packet (using the Internet Control Message Protocol or ICMP), including in the packet a time limit value (known as the “time to live” (TTL)) that is chosen to be small enough so that it will inevitably be exceeded by the duration of the hop to the first router that receives it. The first router will therefore return a Time Exceeded message. This enables traceroute to determine the time required for the hop to the first router.

Traceroute then increases the TLL value and resends the packet so that it will live long enough to pass the first router but will expire by the time it reaches the second router in the path to the destination. The second destination returns another Time Exceeded message, and so forth.

Traceroute determines when the packet has reached its destination by including in the destination address of its header a port number that is outside a normal range. When the destination node receives the packet, it detects the out of range port number, and returns a Port Unreachable message, enabling traceroute to measure the time length of the final hop. As the tracerouting progresses, the process 100 stores (110) the tracerouting data generated hop by hop in a ASCII file in the source network node 12.

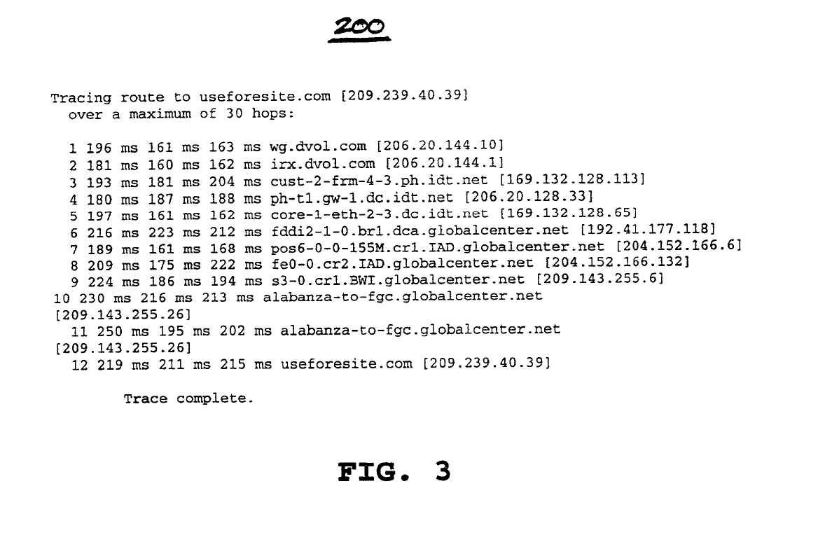

Referring to FIG. 3, a table 200 containing a sample traceroute output from a source network node to a destination network node, i.e., www.useforesite.com [IP address 209.239.40.39] is shown. Each of the lines in the table will be explained in turn.

Tracing route to useforesite.com [209.239.40.39] over a maximum of 30 hops:

The first line of text above refers to the useforesite.com URL (Universal Resource Locator) and the IP address [209.239.40.39] of the site. These two identifiers are one and the same. It's easier for users to remember words than it is to remember numbers so URL's are used to locate other servers while the numbers (i.e., IP addresses) are used by computers to locate another computer.

The second line of text, i.e., maximum of 30 hops indicates that if it takes more than 30 hops to get from this originating node to the destination node's address then stop trying. This number (30) is configurable. Historically, if a trace takes more than 30 hops to anyplace in the world, there's something usually wrong.

Lines 1 and 2:

1 196 ms 161 ms 163 ms wg.dvol.com [206.20.144.10]

2 181 ms 160 ms 162 ms irx.dvol.com [206.20.144.1]

In each line, each of first three sets of numbers (followed by “ms”) is the amount of time in milliseconds that it took for a packet to get from the source node to a receiving node along a path and sent back to the source node on three separate journeys. The receiving node for the first line was at IP address 206.20.144.10. The average round trip to the first node was 173 ms or (196+161+163)÷3=173. The second line in the list represents the hop times to the second node at IP address 206.20.144.1. These times are not cumulative as you pass down the list. Each represents the time it took for that individual node to send the packet all the way back to the source node.

Both lines 1 and 2 are from domain dvol.com so both nodes may be located at the same physical facility, e.g., simply two computers at a single ISP's (Internet Service Provider) facility. Line 1 is the first computer that encountered the packets from the trace. Line 2 represents the second and so on. So the trace first entered the dvol.com facility via the computer at line 1 and was routed over to the computer at line 2 then to idt.net.

Lines 3-5:

3 193 ms 181 ms 204 ms cust-2-frm-4-3.ph.idt.net [169.132.128.113]

4 180 ms 187 ms 188 ms ph-t1.gw-1.dc.idt.net [206.20.128.33]

5 197 ms 161 ms 162 ms core-1-eth-2-3.dc.idt.net [169.132.128.65]

The trace entered idt.net on the computer at line 3. This computer has a designation of ph.idt.net. The packet at line 4 (ph-t1.gw-1.dc.idt.net [206.20.128.33]) has now traveled to a server at idt.net that handles the Washington DC area (dc.idt.net). This server is located in the Philadelphia area but routes all packets to the DC area that need to go to DC. This is shown by the use of ph-t1 at the beginning of the address. This server is in Philadelphia but handles traffic to the DC area. Line 5 (core-1-eth-2-3.dc.idt.net [169.132.128.65]) is indicating that the packet is still at idt.net but are now on a server or router at a core or backbone facility in DC.

Lines 6-11:

6 216 ms 223 ms 212 ms fddi2-1-0.br1.dca.globalcenter.net [192.41.177.118]

7 189 ms 161 ms 168 ms pos6-0-0155M.cr1.IAD.globalcenter.net [204.152.166.132]

8 209 ms 175 ms 222 ms fe0-0.cr2.IAD.globalcenter.net [204.152.166.132]

9 224 ms 186 ms 194 ms s3-0.cr1.BWI.globalcenter.net [209.143.255.6]

10 230 ms 216 ms 213 ms alabanza-to-fgc.globalcenter.net [209.143.255.26]

11 250 ms 195 ms 202 ms alabanza-to-fgc.globalcenter.net [209.143.255.26]

Lines 6-11 are all computers/routers owned by Global Center (globalcenter.net). Their addresses are not as easily deciphered but there is other relevant information worthy of comment. For example, Line 7 has a 155M designation in it. This is most likely a reference to a 155 Mbps OC-3 or Optical Carrier line. This is a fiber optic cable capable of transmission speeds of 155 Megabytes per second.

Line 12:

12 219 ms 211 ms 215 ms useforesite.com [209.239.40.39]

The packet is at the destination server (computer). It only took, on average, 215 ms or slightly less than a quarter of a second for a packet of information to be sent from a source in the Philadelphia area through 11 nodes over 3,000 miles and back again.

Referring again to FIG. 2, after the IP addresses in the list are traced and the network data stored in the ASCII file, the process 100 processes (112) the data contained in the file for display to the user 38 on a GUI 36. Processing the data involves generating a graphical representation of the routes taken by network paths between a source node and all the destination network nodes represented by the list of destination IP addresses used by the source network node to trace routes. Any path can be determined from traceroute data, i.e., the data represents all the network nodes in a given path. For each path, each of the nodes is displayed on the GUI 36 to the user 38 in a geometric shape, such as a circle, square, or triangle, and the nodes in a path are connected by lines.

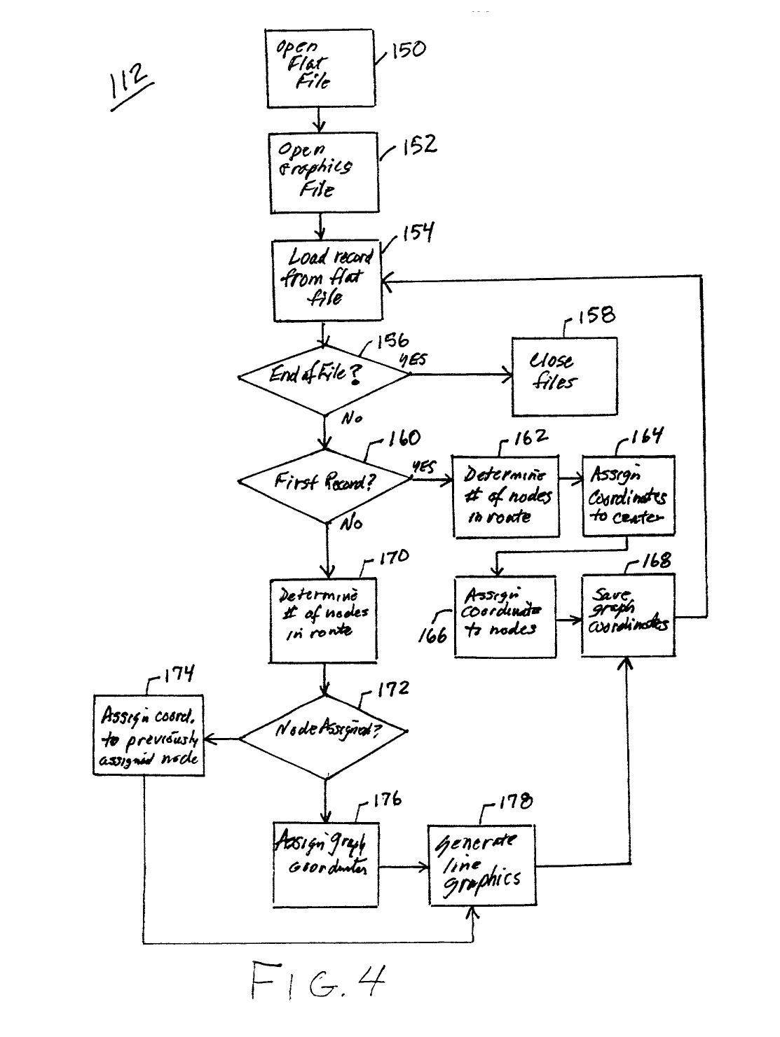

Referring to FIG. 4, the graphing process 112 includes opening (150) the ASCII file containing the stored data and opening (152) a graphics file. The graphics file is opened to store a graphical representation of the data. The graphical representation of the data may be represented in, for example, Hypertext Markup Language (HTML). Using an HTML format allows the graphical representation of data to be displayed as a web-page and saved as a text only or ASCII file that most any computer can read using browser software, such as Netscape Navigator from AOL, Inc. or Internet Explorer from Microsoft Corporation. In addition, using the HTML format allows a user to manipulate items on a display with ease.

The graphing process 112 loads (154) a record from the ASCII file and determines (156) whether the record points to an end-of-file. If the record points to an end-of-file, the graphing process 112 closes (158) the ASCII file and the graphics file. If the record does not point to an end-of-file, the graphing process 112 determines (160) whether the current record is the first record. If the current record is the first record in the ASCII file, the graphing process 112 determines (162) the total number of nodes representing the route in the record. Using a circular display format as an example, the graphing process 112 assigns (164) and stores coordinates of a center position of the circle to the source network node along with the source node's name and/or IP address. For each successive hop in the route, the graphing process 112 assigns (166) graphical coordinates to a node along a radius emanating from the center and generates graphics to represent a line between the two nodes in the hop. The graphing process 112 saves (168) the graphical coordinates and the lines in the graphics file, along with names and/or IP addresses of each of the nodes.

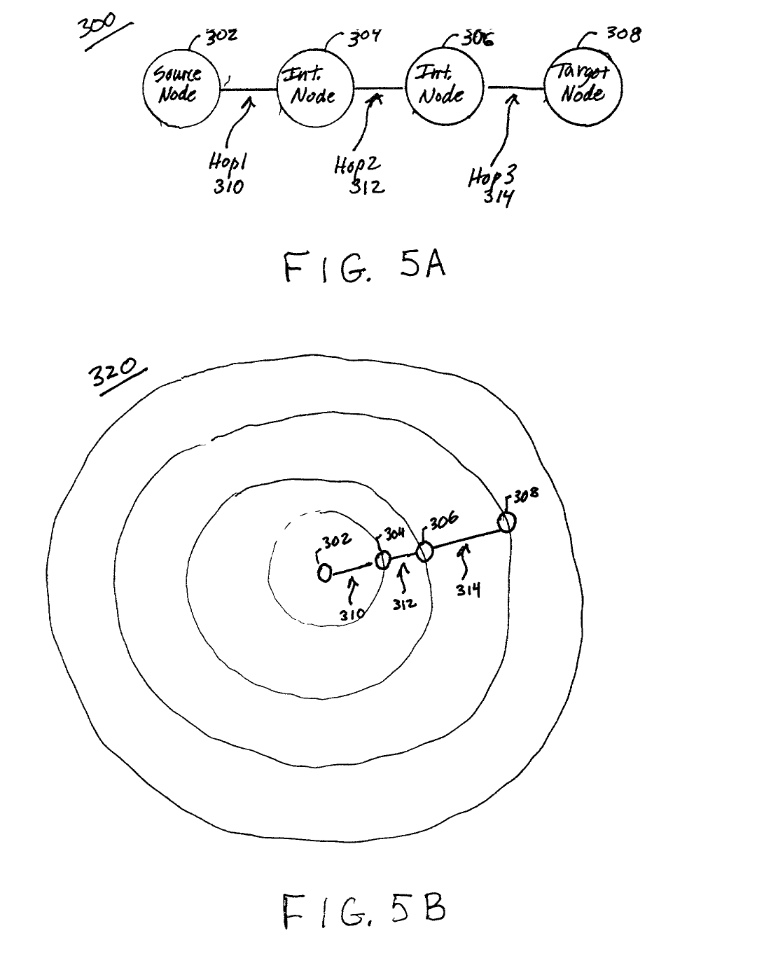

Referring to FIG. 5A, an example route 300 contains four nodes. The four nodes are a source node 302, a first intermediate node 304, a second intermediate node 306 and a destination node 308. A first hop 310 in the route 300 occurs between nodes 302 and 304, a second hop 312 occurs between nodes 304 and 306, and a third hop 314 occurs between nodes 306 and 308. Thus route 300 includes three hops 310, 312 and 314.

Referring to FIG. 5B, a corresponding circular map 320 is shown in tandem with the nodes 302, 304, 306 and 308 assigned coordinates on increasing radii from the center source node 302.

Referring again to FIG. 4, if the current record is not the first record in the ASCII file, the graphing process 112 determines (170) the number of nodes in the path represented by the record. For each successive hop in the route, the graphing process 112 determines (172) whether a node in the hop has been assigned graphical coordinates in a previous route. If the node in the hop has been assigned graphical coordinates, the graphing process 112 assigns (174) the graphical coordinates of the current node to the graphical coordinates of the previously assigned node and generates graphics to represent a line between the two nodes in the hop. Thus, common points in the routes are identified.

If the node in the hop has not been assigned graphical coordinates previously, the graphing process 112 assigns (176) graphical coordinates to the node along an arbitrary radius emanating from the center and adjacent to the previous record's radius and generates (178) graphics to represent a line between the two nodes in the hop. The graphing process 112 saves (168) the graphical coordinates and the lines in the graphics file, along with names and/or IP addresses of each of the nodes. The process 112 loads (154) the next record in the ASCII file.

Referring again to FIG. 2, the process 100 displays (114) a graph represented by the graphics files on the GUI 36 of the input/output device 34 to the user 38 and determines (102) whether the timer has expired.

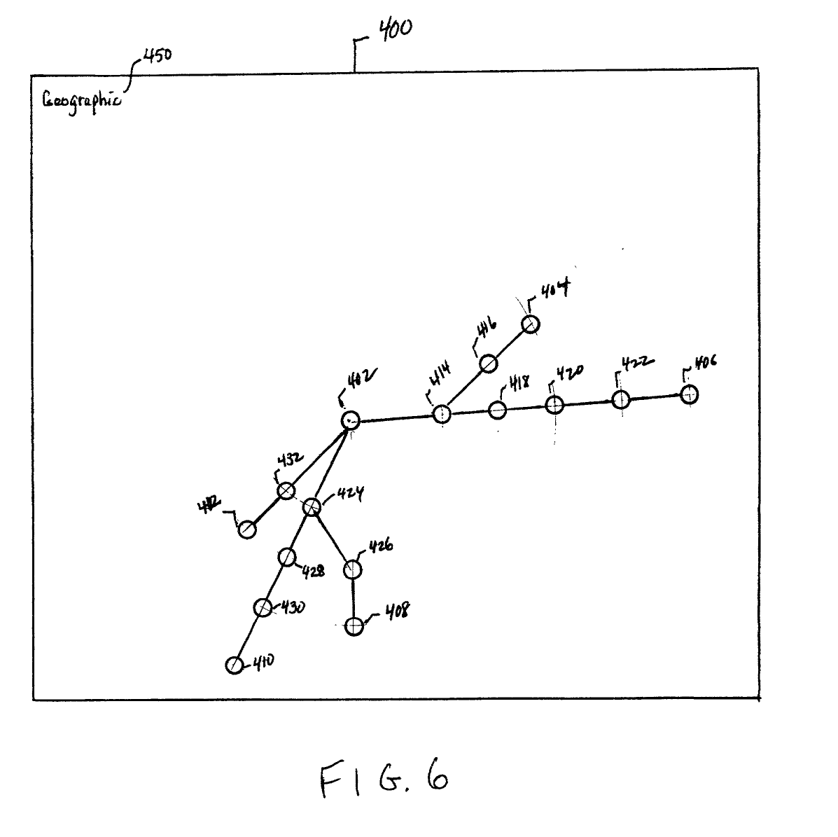

Referring to FIG. 6, an exemplary graph 400 is shown. The graph 400 illustrates routes from a source node 402 to five destination nodes (also referred to as end nodes or target nodes) 404, 406, 408, 410 and 412.

A first route includes three hops from node 402, through intermediate nodes 414, 416, to end node 404. A second route includes five hops from node 402, through intermediate nodes 414, 418, 420, 422, to end node 406. A third route includes three hops from node 402, through intermediate nodes 424, 426, to end node 408. A fourth route includes four hops from node 402, through intermediate nodes 424, 428, 430, to end node 410. A fifth route includes two hops from node 402, through intermediate node 432 to end node 404.

The graph 400 is in the form of a tree with, for example, a network server at the route of the tree and each of the target nodes 404, 406, 408, 410 and 412 as leaves.

The graph 400 is web-based and allows a user to view network data from a large number of separate sources simultaneously in a user-friendly environment. The path from the root to a leaf represents the route discovered by the traceroute utility. In one example, each of the nodes in the graph 400 is assigned a color and shape representing a time to travel to that node on the route and the network on which the underlying router resides. The network on which the router resides is determined from its IP address. Nodes in a network may be given similar shapes (e.g., squares for a first network, circles for a second network, and triangles for a third network).

For example, using a statistical analysis of historical performance, a threshold based on a distance from the root node to a target node may be computed from data gathered over a long period of time. Whether an observation is above, close to, or well below the threshold may determine the color of the target node. If data packets do not reach the target node, the target node can be colored white, for example.

In some examples, the nodes in the graph 400 are hard to interpret because of the number of routes traced. Since the graph 400 is web-like and an HTML page display, the user 38 can click and drag intermediate nodes to move the intermediate nodes about in the graph 400.

In another example, intermediate nodes are colored based on the travel time over the hop from the previous node along a route from the root node. Two color schemes are used, i.e., historical and geographic.

In the historical color scheme, a node color is based on a relation of current hop time to times for the hop observed in the past. The color indicates the hop time is, for example, much higher, somewhat higher, or about the same as what has been seen in the past.

In the geographical color scheme, two different colors are used. One color is used for nodes on the user's network and another color for nodes on other networks. A shade of the color is determined by whether a hop time accounts for a large, medium or small portion of the total time travel from the root node to the target node. The geographic color scheme shows where the travel time is distributed over the route.

Shading of colors can be used. For example, darker shades may correspond to cross-country hops, though not always. The historical color scheme shows whether a hop time has increased recently over its observed past levels.

Which scheme is being displayed (i.e., geographic or historical) is indicated to the user by an indicator 450 in a corner of the graph 400. The user may switch from one scheme to the other scheme by clicking on the indicator.

In another scheme, the user 38 can select from a list of network service providers (e.g. Genuity, Sprint, Verio, etc.) and the nodes of that provider will be distinctively colored.

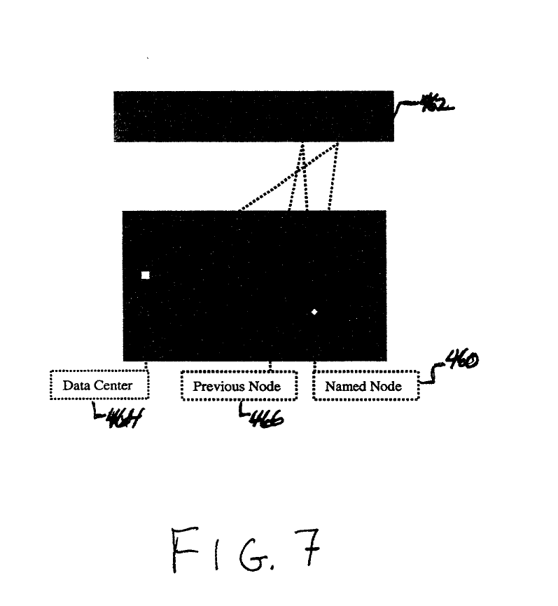

Referring to FIG. 7, when the user places a cursor over a selected node 460 in the graph 400, the node name and/or IP address 462 is displayed, along with the node's associated data. Two numbers follow the node name and/or IP address 462. A first number, 0.37 ms, is a hop time, i.e., the travel time from the previous node 466 along the route to selected node 460. A second number, 7.27 ms, is a time needed for packets to travel along the route from a source node 464 to the selected node 460. The first and second numbers are typically measured in milliseconds. In addition, all the routes through the selected node 422 are highlighted while the cursor is over the node 460.

When the user clicks on a node on the graph 400, all routes passing through the node are shown and all of the intermediate nodes not linked to the selected node are hidden to clarify the display. For example, clicking on node 414, two routes and highlighted and three routes are hidden. Specifically, the routes from node 402 to node 406 and from node 402 to node 404 are highlighted since both of these routes travel through node 414. The routes from node 402 to node 412, from node 402 to node 410 and from node 402 to node 408 are hidden.

A histogram representing travel time may also be viewed by clicking on a node. If more than one route travels through the node, pressing the up/down arrow keys on the input/output device 34 repeatedly cycles through each of the routes passing through the selected node.

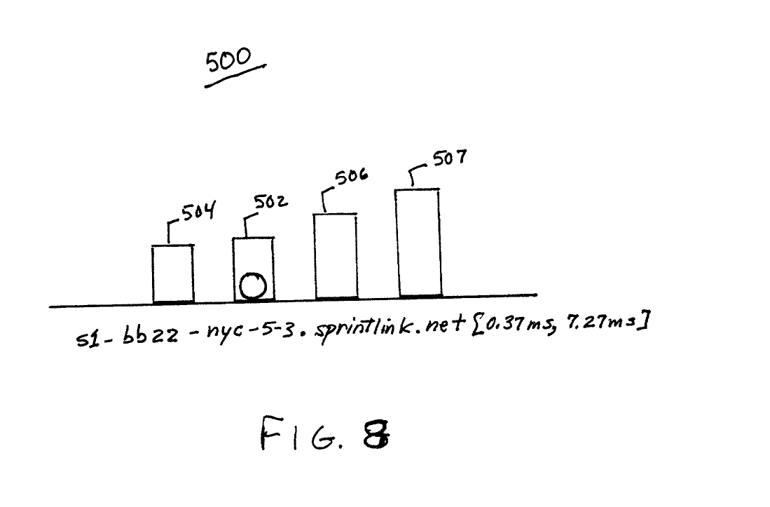

Referring to FIG. 8, an exemplary travel time histogram 500 is shown in which node 414 (of FIG. 6) is selected. In the histogram 500 node 414 is represented by a circle in a bar 502. The travel time histogram 500 displays a bar for each node along the selected route with the route node 402 on the left and the target node 404 on the right. Specifically, bar 504 represents node 402, bar 502 represents node 414, the selected node, bar 506 represents node 416 and bar 508 represents the target node 404. The height of each bar representing each node in the route represents a travel time of packets from the root node 402 to the node represented by the bar. The height is calculated from the time stored in the graphic file. In one example, the color of each bar corresponds to the color of the node in the graph 400. The hop time for a node is represented in the difference in the height of the node's bar and the height of the previous bar.

In another example, the travel time histogram includes a line (not shown) representing a threshold used to color or shade the target node. If a threshold line is shown, the bars are sized in proportion to the threshold.

Clicking on a node in the graph 400, the user 38 may use the left and right hand arrow keys of the input/output device 34 to move along the route in which the node resides. Movement from node to node along the route correspondingly changes the bar heights, and possibly bar colors, in the corresponding travel time histogram.

Other embodiments are within the scope of the following claims. For example, the ASCII file can be stored on a remote computer and the process 100 can be executed in one computer and the graphics file transferred to a second computer for display.

What is claimed is:

1. A method comprising:
in a network, collecting data about a packet passing from a source system to a destination system;
generating a markup language graphical file based on the collected data; and
displaying the markup language graphics file.

2. The method of claim 1 in which collecting comprises:
tracing routes from the source system to the destination system; and
for each of the routes, storing a node identification, a hop time, and a travel time from the source system to an intermediate node.

3. The method of claim 2 in which the node identification comprises a node name.

4. The method of claim 2 in which the node identification comprises an Internet Protocol (IP) address.

5. The method of claim 2 in which generating comprises:
determining a number of nodes in each of the routes;
assigning coordinates to each of the systems in each of the routes; and
storing the coordinates and associated node identification, hop time, and travel time from source system to each of the systems in each of the routes in the markup language file.

6. The method of claim 5 in which the markup language comprises Hypertext Markup Language (HTML).

7. The method of claim 5 in which the markup language comprises Extensible Markup Language (XML).

8. The method of claim 5 in which each of the systems on each of the routes is positioned on an imaginary line emanating from a center of a geometric structure.

9. The method of claim 8 in which the geometric structure comprises a circle.

10. The method of claim 8 in which the geometric structure comprises a square.

11. The method of claim 1 in which displaying comprises showing an image represented by the markup language graphics file on browser software.

12. The method of claim 11 in which the image includes geometric shapes representing nodes in each route.

13. The method of claim 12 in which a color of the displayed shapes represents a network.

14. The method of claim 12 in which a color of the displayed shapes represents a potential timing problem.

15. The method of claim 12 further comprising displaying a node identification and route timing data when an element of the displayed file is highlighted by a user.

16. The method of claim 1 further comprising displaying a time travel histogram of a highlighted displayed file.

17. A method comprising:
in a network, tracing routes from a source system to the destination systems;
for each of the routes, storing data representing a node identification, a hop time, and a travel time from the source system to an intermediate node;
generating an interactive markup language graphics file for the data; and
displaying the interactive markup language graphics file.

18. The method of claim 17 in which generating comprises:
determining a number of systems in each of the routes;
assigning coordinates to each of the systems in each of the routes; and
storing the coordinates and associated node identification, hop time, and travel time from source system to each of the systems in each of the routes in the markup language file.

19. The method of claim 17 in which displaying comprises viewing an image represented by the markup language graphics file on browser software.

20. The method of claim 19 in which the image includes geometric shapes representing systems in each route.

21. The method of claim 20 in which a color of the geometric shapes represents a network.

22. The method of claim 20 in which a color of the geometric shapes represents a potential timing problem.

23. The method of claim 19 further comprising displaying a node identification and route timing data when any of the geometric shapes is highlighted by a cursor on an input/output device.

24. The method of claim 19 further comprising displaying a time travel histogram of the highlighted geometric shape.

25. The method of claim 17 in which the data is stored in a remote computer system.

26. The method of claim 17 in which the interactive markup language graphics file is displayed on a remote system.

27. A computer program stored on a computer readable-medium, the computer program comprising instructions that cause a computer to:
collect data in a network from a source system to destination systems;
generate a markup language graphics file for the collected data; and
display the markup language graphics file.

28. A computer program stored on a computer readable-medium, the computer program comprising instructions that cause a computer to:
periodically trace network routes from a source system to the destination systems;
for each of the routes, store data representing a node identification, a hop time, and a travel time from the source system to an intermediate node;
generate an interactive markup language graphics file for the data; and
display the interactive markup language graphics file.
